(19) United States
(12) Patent Application Publication
(10) Pub. No.: US 2005/0117945 A1
(43) Pub. Date: Jun. 2, 2005

(54) Waste toner transferring apparatus and electrophotographic printer adopting the same

(76) Inventor: Myoung-suck Lee, Gyeongsangbuk-do (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/919,362

(22) Filed: Aug. 17, 2004

(30) Foreign Application Priority Data
Nov. 27, 2003 (KR) 2003-84970

(51) Int. Cl. G03G 21/00

(52) U.S. Cl. 399/358

(57) ABSTRACT

Provided is a waste toner transferring apparatus, which includes elastic brushes which are installed so as to be placed within grooves between spiral wings of an auger. As the auger rotates, the elastic brushes elastically interfere with the spiral wings so that waste toner does not stagnate within the grooves.

### CROSS REFERENCE TO RELATED APPLICATIONS

This application claims the priority of Korean Patent Application No. 2003-84970, filed on Nov. 27, 2003, in the Korean Intellectual Property Office, the disclosure of which is incorporated herein in its entirety by reference.

### BACKGROUND OF THE INVENTION

1. Field of the Invention

The present invention relates to an electrophotographic printer. More particularly, the present invention relates to an electrophotographic printer including a waste toner transferring apparatus which transfers waste toner, which is generated during printing, to a container for containing the waste toner.

2. Description of the Related Art

In an image forming process that takes place in an electrophotographic printer, light corresponding to image information is applied from exposure equipment to a photoreceptor that is charged to have a uniform potential to form an electrostatic latent image on the photoreceptor. A developer supplies toner to the electrostatic latent image to form a toner image. Typical color electrophotographic printers use four developers containing cyan (C) toner, magenta (M) toner, yellow (Y) toner, and black (K) toner, respectively. The toner image formed on the photoreceptor is transferred directly to a recording medium (such as paper) or transferred to the same via an intermediate transfer medium. When the recording medium passes by a fuser, the toner image is fused to the recording medium by heat and pressure. Accordingly, a mono-color image or a color image is printed on the recording medium.

Dry-type electrophotographic printers use toner powder. Waste toner remaining on the photoreceptor or the intermediate transfer medium during image formation must be removed. The removed waste toner is typically contained in a container. Electrophotographic printers typically include a waste toner transferring apparatus for transferring waste toner to the container.

FIG. 1 is a schematic view of a conventional waste toner transferring apparatus. Waste toner removed from a photoreceptor or an intermediate transfer medium by a cleaning device (not shown) enters into a duct 2 via an inlet 1. A shaft 4 is installed in the duct 2 and rotated by a driving motor 3. A conveying coil 5 is wound around an end of the shaft 4. Reference numeral 6 denotes a pipe via which the duct 2 is connected to a container (not shown). The conveying coil 5 extends to the inside of the pipe 6. Through the use of the conveying coil 5, the waste toner introduced into the duct 2 via the inlet 1 is transferred to the container via the pipe 6.

If the waste toner is left in the duct 2 of the conventional waste toner transferring apparatus for a long period of time, fine particles of the waste toner may clump due to their affinity and become attached to an outer circumference of the shaft 4. In particular, if the waste toner is left for a long period of time in an environment of high temperature and high humidity, the waste toner becomes solid. As shown in FIG. 2, when the solid waste toner attached to the shaft 4 fills a space B defined by the outer circumference of the shaft 4 and the conveying coil 5, the solid waste toner is not detached from the space B even when the shaft 4 and the conveying coil 5 rotate. Then, the waste toner piles up in the cleaning device. If the waste toner continues to pile up, the waste toner may enter into the image forming apparatus.

### SUMMARY OF THE INVENTION

The present invention provides an improved waste toner transferring apparatus which can effectively transfer waste toner removed from an image receiver, such as a photoreceptor, an intermediate transfer medium, or the like, to a container without the waste toner piling up, and an electrophotographic printer including the waste toner transferring apparatus.

According to an aspect of the present invention, there is provided a waste toner transferring apparatus in an electrophotographic printer, which transfers waste toner removed from image receivers which temporarily receive toner images, to a container. The apparatus comprises an auger, which includes a shaft and spiral wings formed on an outer circumference of the shaft and which transfers the waste toner while rotating, and elastic brushes, which are installed so as to be placed in grooves between the spiral wings. As the auger rotates, the elastic brushes elastically interfere with the spiral wings so that the waste toner does not remain in the grooves.

According to another aspect of the present invention, there is provided an electrophotographic printer comprising image receivers which temporarily receive toner images during image formation, a cleaning device which removes waste toner residuals from the image receivers, a container which holds the removed waste toner, and a waste toner transferring apparatus which transfers the waste toner from the cleaning device to the container. The used toner transferring apparatus includes an auger which includes a shaft and spiral wings formed on an outer circumference of the shaft and transfers the waste toner while rotating, and elastic brushes, which are installed so as to be placed in grooves between the spiral wings. As the auger rotates, the elastic brushes elastically interfere with the spiral wings so that the waste toner does not remain within the grooves.

The elastic brushes preferably elastically contact the outer circumference of the shaft.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional waste toner transferring apparatus;

FIG. 2 is a detailed view of portion A of FIG. 1;

FIG. 3 is a schematic view of an electrophotographic printer according to an embodiment of the present invention;

FIG. 4 is a vertical cross-section of a waste toner transferring apparatus according to an embodiment of the present invention;

FIG. 5 is a horizontal cross-section of the waste toner transferring apparatus of FIG. 4; and

FIG. 6 is a cross-section taken along line II-II of FIG. 5.

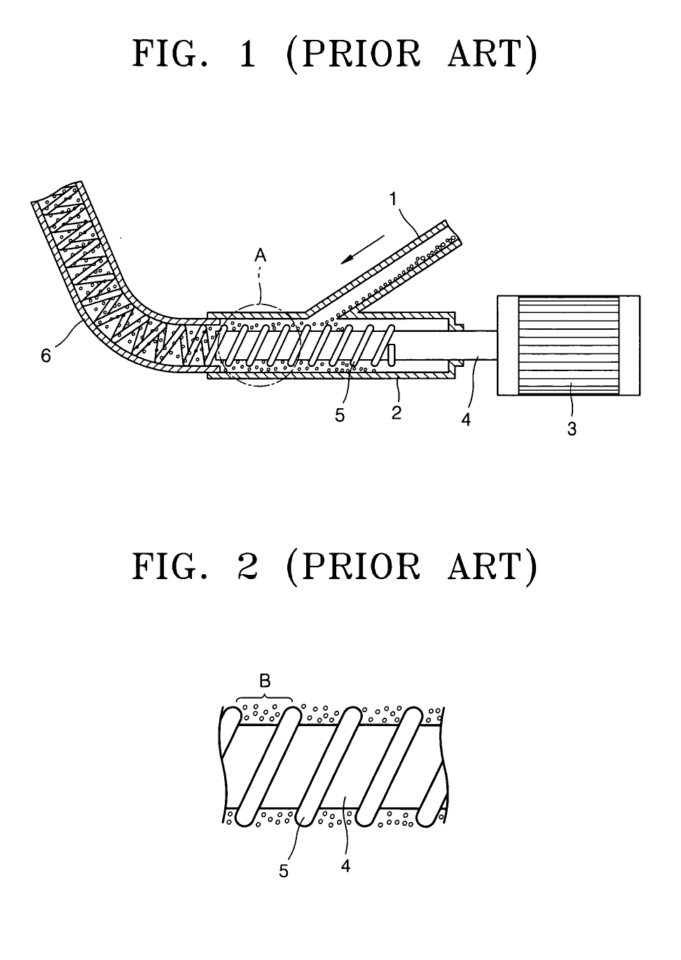

Throughout the drawings, life reference numbers are used to depict like features and structures.

### DETAILED DESCRIPTION OF AN EXEMPLARY EMBODIMENT

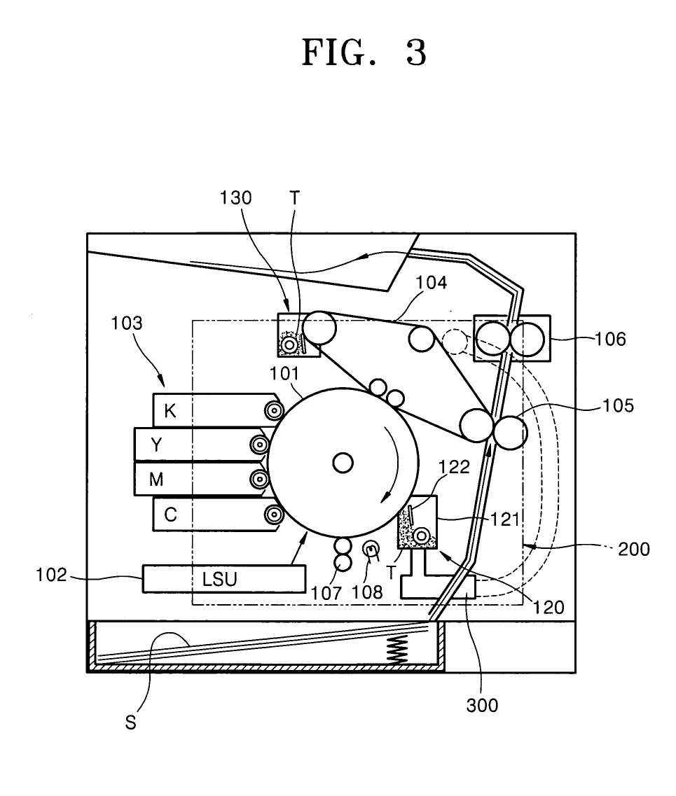

Referring to FIG. 3, an electrophotographic printer according to an embodiment of the present invention includes a photoconductive drum 101, an exposure unit 102, a developer 103, and a transfer belt 104.

The photoconductive drum 101, which is an example of a photoreceptor, is preferably manufactured by forming a photoconductive material layer on an outer circumference of a metal drum. The photoconductive drum 101 may be replaced by a belt-type photoreceptor (not shown), as will be understood by those of ordinary skill in the art.

The exposure unit 102 projects light corresponding to image information onto the photoconductive drum 101, which is charged to have a constant potential, thereby forming an electrostatic latent image on the photoconductive drum 101. A laser scanning unit (LSU), which generally uses a laser diode as a light source, is used as the exposure unit 102.

The developer 103 includes four developers C, M, Y, and K which contain cyan (C) toner powder, magenta (M) toner powder, yellow (Y) toner powder, and black (K) toner powder, respectively. The developers C, M, Y, and K supply the toner to the electrostatic latent image formed on the photoconductive drum 101, thereby forming C, M, Y, and K toner images.

The transfer belt 104 is an example of an intermediate transfer medium which receives the toner images from the photoconductive drum 101 and transfers them to a recording medium S. Although not shown in FIG. 3, the transfer belt 104 may be replaced by a transfer drum. The C, M, Y, and K toner images sequentially formed on the photoconductive drum 101 are sequentially transferred to the transfer belt 104 and overlapped thereon to form a color toner image. Preferably, the linear velocity of the transfer belt 104 is equal to that of a rotation of the photoconductive drum 101. The length of the transfer belt 104 must be equal to or greater than the recording medium S, which is a final destination of the color toner image.

Reference numeral 105 denotes a transfer roller which faces the transfer belt 104. While the color toner image is being transferred to the transfer belt 104, the transfer roller 105 is separated from the transfer belt 104. After the color toner image is completely transferred to the transfer belt 104, the transfer roller 105 is pressed against the transfer belt 104 and transfers the color toner image to the recording medium S. Reference numeral 106 denotes a fuser. When the recording medium S to which the toner image is transferred passes through the fuser 106, the toner image is fused to the recording medium S by heat and pressure. Reference numeral 107 denotes a charger which charges the photoconductive drum 101 so that the photoconductive drum 101 has a uniform potential. Reference numeral 108 denotes a discharger which removes charges from the charged photoconductive drum 101.

If the exposure unit 102 applies an optical signal corresponding to information about a cyan (C) component of an image to the photoconductive drum 101, which is charged to a uniform potential, a resistance in a portion of the photoconductive drum 101 to which light is applied decreases, while charges are detached from an outer circumference of the photoconductive drum 101. Hence, a potential difference is generated between the light-applied portion of the photoconductive drum 101 and the remaining portion. Consequently, an electrostatic latent image is formed on the outer circumference of the photoconductive drum 101. When the electrostatic latent image approaches the developer C due to the rotation of the photoconductive drum 101, the C toner contained in the developer C is attached to the electrostatic latent image, thereby forming a C toner image. When the C toner image approaches the transfer belt 104 due to the rotation of the photoconductive drum 101, the C toner image is transferred to the transfer belt 104 by a potential difference between the photoconductive drum 101 and the transfer belt 104 and/or a contact pressure between them. After the C toner image is completely transferred to the transfer belt 104, the M, Y, and K toner images are sequentially transferred to the transfer belt 104 in the above-described manner and overlap one another on the transfer belt 104, thereby forming a color toner image. While the recording medium S passes between the transfer belt 104 and the transfer roller 105, the color toner image is transferred to the recording medium S. Subsequently, the color toner image is fused to the recording medium S by the heat and pressure of the fuser 106, thereby completing color image formation.

The photoconductive drum 101 and the transfer belt 104 are image receivers which temporarily receive toner images before the toner images are transferred to the recording medium S. While the toner images are being transferred to the photoconductive drum 101, the transfer belt 104, and the recording medium S, some toner remains on the photoconductive drum 101 or the transfer belt 104. To perform further printing, it is preferable to remove the waste toner from the image receivers. The removed waste toner is contained in a container 200 and discarded later. Some of the waste toner may re-enter the developer 103 and be recycled. However, in general color image forming apparatuses, different color toners are mixed together and thus cannot be recycled.

Referring to FIG. 3, in a cleaning device 120 for removing waste toner from the photoconductive drum 101, waste toner removed from the photoconductive drum 101 by a blade 122 is temporarily contained within a housing 121. A cleaning device 130 for removing waste toner remaining in the transfer belt 104 may have a similar structure as the cleaning device 120. Reference numeral 200 denotes a container which contains waste toner. A waste toner transferring apparatus 300 transfers the waste toner that has been removed from the photoconductive drum 101 by the cleaning device 120 to the container 200. The cleaning device 130 may be connected directly to the container 200. Although not shown in FIG. 3, another waste toner transferring apparatus may be further included to transfer waste toner from the cleaning device 130 to the container 200.

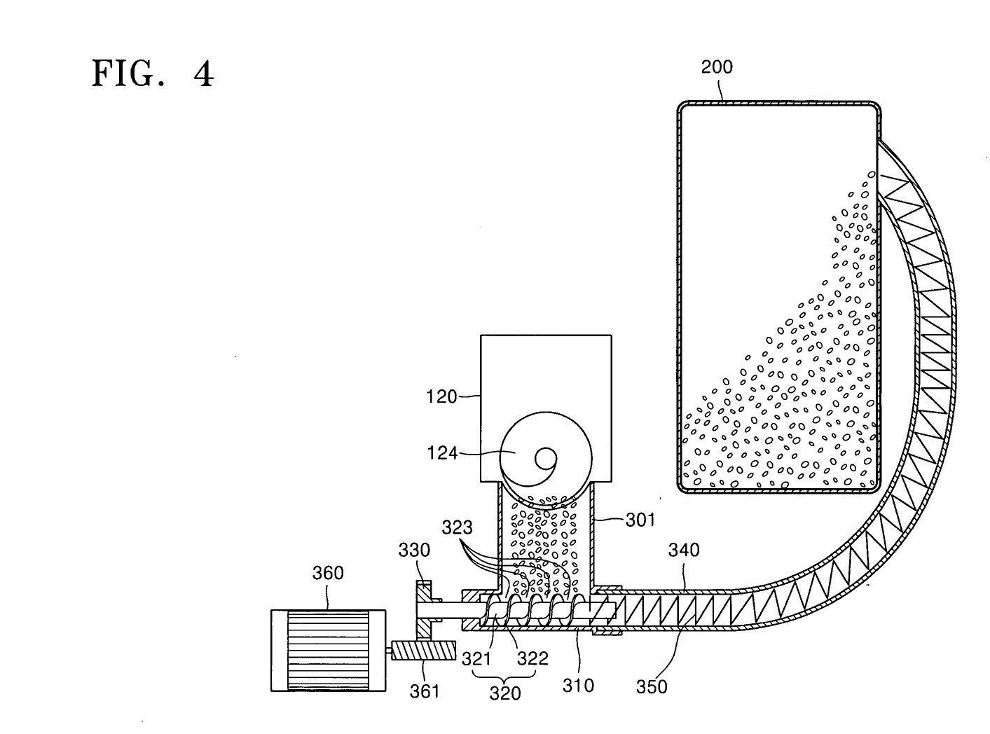

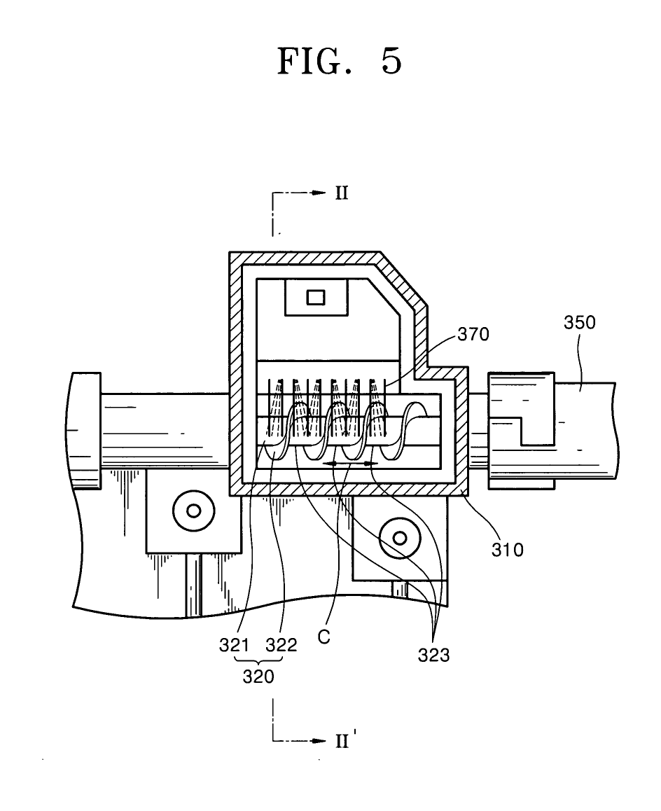

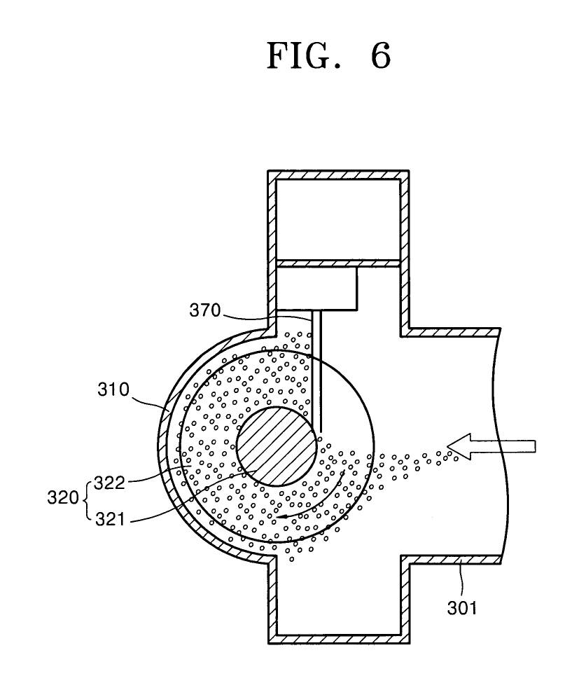

FIGS. 4 and 5 are vertical and horizontal cross-sections, respectively, of the waste toner transferring apparatus 300. FIG. 6 is a cross-section taken along line II-II of FIG. 5.

Referring to FIGS. 4 and 5, waste toner is introduced into a duct 310 via an inlet 301. The inlet 301 is connected to an outlet 124 of the cleaning device 120. An auger 320 is installed within the duct 310. The duct 310 is connected to the container 200 via a pipe 340.

The auger 320 includes a shaft 321 and a spiral wing 322 formed on an outer circumference of the shaft 321. A gear 330 is combined with the shaft 321. Reference numeral 360 denotes a driving motor to which a worm gear 361 is coupled. The worm gear 361 is connected to the gear 330. The driving motor 360 rotates the auger 320. A conveying coil 350 may be installed within the pipe 340. One end of the conveying coil 350 is coupled to the shaft 321 of the auger 320, and the other end extends to the container 200. The conveying coil 350 rotates with a rotation of the auger 320.

The waste toner removed from the photoconductive drum 101 by the cleaning device 120 enters into the duct 310 via the inlet 301. The waste toner is collected in grooves 323, each of which is formed between adjacent spiral wings 322 of the auger 320. When the driving motor 360 rotates, the auger 320 in the duct 310 is rotated, and the conveying coil 350 connected to the auger 320 is also rotated. The waste toner collected in the grooves 323 is introduced into the pipe 340 by the thrust of the spiral wings 322. Also, the introduced waste toner is transferred to the container 200 via the pipe 340 by the thrust of the conveying coil 350.

While the image forming apparatus is not performing printing, the auger 320 does not rotate. Hence, the waste toner collected in the grooves 323 may be left for a long period of time. Since the waste toner is a fine powder, powder particles may combine together due to their affinity. If the combined waste toner absorbs humidity, it becomes solid and may become attached to the shaft 321 or the wings 322. When the auger 320 transfers the solid waste toner collected in the grooves 323 to the pipe 340, the transfer efficiency of the auger 320 is reduced. Also, even if the waste toner powder does not become solid, it may not be transferred to the pipe 340 while spinning around over the grooves 323.

As shown in FIGS. 5 and 6, the waste toner transferring apparatus 300 includes elastic brushes 370 on the grooves 323 in order to prevent the incomplete transfer of waste toner. One end of each of the elastic brushes 370 is fixed to the duct 310, and the other end is located within each of the grooves 323. Preferably, the elastic brushes 370 extend so as to elastically contact the outer circumference of the shaft 321. Accordingly, as the driving motor 360 rotates, the elastic brushes 370 interfere with the spiral wings 322 and elastically move in a direction indicated by an arrow C of FIG. 5. By moving as described above, the elastic brushes 370 loosen the waste toner collected in the grooves 323 and prevent the waste toner from becoming stuck in the grooves 323. Hence, no waste toner remains on the outer circumference of the shaft 321 and the surfaces of the spiral wings 322. Also, waste toner attached to the outer circumference of the shaft 321 or the surfaces of the spiral wings 322 for a long period of time can be removed to prevent the grooves 323 from being blocked by the solid waste toner.

An electrophotographic printer according to an embodiment of the present invention as described above can prevent waste toner from piling up and solidifying in grooves between the spiral wings, by including elastic brushes. Consequently, the waste toner transfer efficiency of an auger can be increased.

While the present invention has been particularly shown and described with reference to an exemplary embodiment thereof, it will be understood by those of ordinary skill in the art that various changes in form and details may be made therein without departing from the spirit and scope of the present invention as defined by the following claims.

1. A waste toner transferring apparatus in an electrophotographic printer, which transfers waste toner removed from image receivers which temporarily receive toner images, to a container, the apparatus comprising:
an auger, which includes a shaft and spiral wings formed on an outer circumference of the shaft and transfers the waste toner while rotating; and
elastic brushes, which are installed so as to be placed in grooves between said spiral wings,
wherein as the auger rotates, the elastic brushes elastically interfere with the spiral wings so that the waste toner does not remain in the grooves.

2. The waste toner transferring apparatus of claim 1, wherein the elastic brushes elastically contact the outer circumference of the shaft.

3. An electrophotographic printer comprising:
image receivers, which temporarily receive toner images during image formation;
a cleaning device, which removes waste toner residuals from the image receivers;
a container, which holds the removed waste toner; and
a waste toner transferring apparatus, which transfers the waste toner from the cleaning device to the container and comprises:
an auger, which includes a shaft and spiral wings formed on an outer circumference of the shaft and transfers the waste toner while rotating; and
elastic brushes, which are installed so as to be placed in grooves between the spiral wings,
wherein as the auger rotates, the elastic brushes elastically interfere with the spiral wings so that the waste toner does not remain within the grooves.

4. The electrophotographic printer of claim 3, wherein the elastic brushes elastically contact the outer circumference of the shaft.
